(19) United States
(12) Patent Application Publication
(10) Pub. No.: US 2008/0095896 A1
(43) Pub. Date: Apr. 24, 2008

(54) Apparatus for making ice cream sandwiches with servo-driven paper feed

(76) Inventors: Martin J. Mueller, Oldsmar, FL (US); Richard W. Mueller, Oldsmar, FL (US); Michael A. Weigandt, Oldsmar, FL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/583,335

(22) Filed: Oct. 19, 2006

(51) Int. Cl. A23L 1/31

(52) U.S. Cl. 426/92

(57) ABSTRACT

An apparatus for making and wrapping ice cream sandwiches includes a dispensing nozzle associated with a pair of wafer magazines for sequentially making ice cream sandwiches, with a transfer rotor provided for sequentially transferring each sandwich to an associated conveyor. The apparatus includes a sandwich wrapper which sequentially receives and individually wraps each sandwich. Notably, the wrapper includes a wrapper feed mechanism for advancing wrapping material independently of a cutting mechanism of the wrapper, thereby greatly facilitating versatile operation of the machine for wrapping sandwiches of varying sizes.

### TECHNICAL FIELD

The present invention relates generally to an apparatus for making and wrapping comestibles, and in particular, ice cream sandwiches, and more particularly to an apparatus for making wrapped ice cream sandwiches including a servo-driven wrapper feed mechanism which greatly facilitates versatile operation, by facilitating convenient and efficient reconfiguration of the apparatus for making and wrapping sandwiches having differing sizes.

### BACKGROUND OF THE INVENTION

Machines for making comestibles such as ice cream confections, in particular, ice cream sandwiches, are well-known in the prior art. Typically, such machines include an arrangement whereby ice cream is dispensed between associated outer wafers of a sandwich, and each sandwich thereafter individually wrapped for subsequent cartoning, storage, and shipment.

U.S. Pat. No. 2,794,404, to Rapp, No. U.S. Pat. No. 3,119,353, to Roehn, No. U.S. Pat. No. 3,316,860, to Peterson, U.S. Pat. No. 3,600,875, to Buob, U.S. Pat. No. 3,828,660, to Mueller, U.S. Pat. No. 4,078,362, to Ellis, U.S. Pat. No. 3,834,119, to Armitt, U.S. Pat. No. 4,098,057, to Holcomb, U.S. Pat. No. 5,583,933, to Price, U.S. Pat. No. 4,612,852, to Price, U.S. Pat. No. 4,682,664, to Price, U.S. Pat. No. 5,493,957, to Kennedy, U.S. Pat. No. 5,540,141, to Grubzak, and U.S. Pat. No. 6,016,639, to Spencer, all of which are hereby incorporated by reference, illustrate various ice cream sandwich machines.

Ice cream sandwich making machines, such as described above, typically are configured to include a single, common electric drive, with suitable belts, gearing, cams, and like mechanical arrangements provided for operating the various components of the machine, in unison with each other, driven by the single, common drive.

Improvements in the machines such as described above have principally concerned flexible and versatile operation of the machines, with the capability to adjust the machinery to allow for making of sandwiches of different sizes. Naturally some sandwiches are longer, wider, thicker, etc., depending upon the specific configuration.

One of the most important developments in such machines was the ability to change gearing, which thereby permitted the wrapping material to be made shorter or longer to accommodate different sandwich sizes. This is typical of existing machines, with such gearing, or like mechanical changes, typically required to modifying a machine for making sandwiches of differing sizes.

The present invention desirably avoids the need to make such mechanical changes in connection with the wrapper feeding mechanism of an ice cream sandwich-making machine, thereby facilitating versatile and efficient operation of the apparatus.

### SUMMARY OF THE INVENTION

In accordance with the present invention, an apparatus for making wrapped ice cream sandwiches is disclosed which facilitates efficient and versatile conversion of the apparatus for manufacture of sandwiches of differing sizes. In particular, the apparatus includes a servo-driven wrapper feed mechanism, which is operable independently of a common drive for remaining components of the apparatus. By this arrangement, the amount of wrapping material fed for wrapping each of the individual sandwiches can be very readily altered for wrapping sandwiches of varying sizes.

In accordance with the illustrated embodiment, the present apparatus includes a pair of wafer magazines for respectively retaining a plurality of wafers, and a dispensing nozzle positioned generally intermediate of the wafer magazines. The nozzle dispenses ice cream between a respective pair of wafers to sequentially form a plurality of sandwiches, each comprising a pair of the wafers with ice cream therebetween.

A transfer rotor positioned beneath the wafer magazines receives each of the sandwiches, and transfers each sandwich to a sandwich conveyor for advancement along the conveyor. The conveyor sequentially receives the sandwiches from the transfer rotor, and conveys each sandwich to a sandwich wrapper for individually wrapping each sandwich.

The sandwich wrapper includes a wrapper feed mechanism for advancing wrapping material from an associated roll, and a cutting mechanism for cutting individual wrappers from the wrapping material. Notably, in accordance with the present invention, the wrapper feed mechanism includes a servo-drive, operable independently of the drive for the cutting mechanism (typically the common drive for the apparatus) to thereby facilitate wrapping of ice cream sandwiches of varying sizes.

During development of the present invention, it was discovered that properly matching the wrapping material, attendant to stopping and starting of the apparatus during high speed operation (as high as 140 sandwiches per minute, or more), was highly problematic. Frequently, an excessive quantity of the wrapping material was fed, thereby undesirably jamming the wrapper mechanism.

Significantly, by virtue of the servo-driven operation of the wrapper feed mechanism, the feed mechanism can be operated to reset the position of the wrapping material attendant to stopping of the apparatus. In particular, the wrapper feed mechanism can be operated to retract a leading edge of the wrapping material attendant to stopping of the apparatus, or by acting to assure proper feed of the wrapper material when operation of the apparatus is reinitiated.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for making ice cream sandwiches embodying the principals of the present invention; and

FIG. 2 is a diagrammatic view of a wrapper cutting mechanism of the apparatus of FIG. 1.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

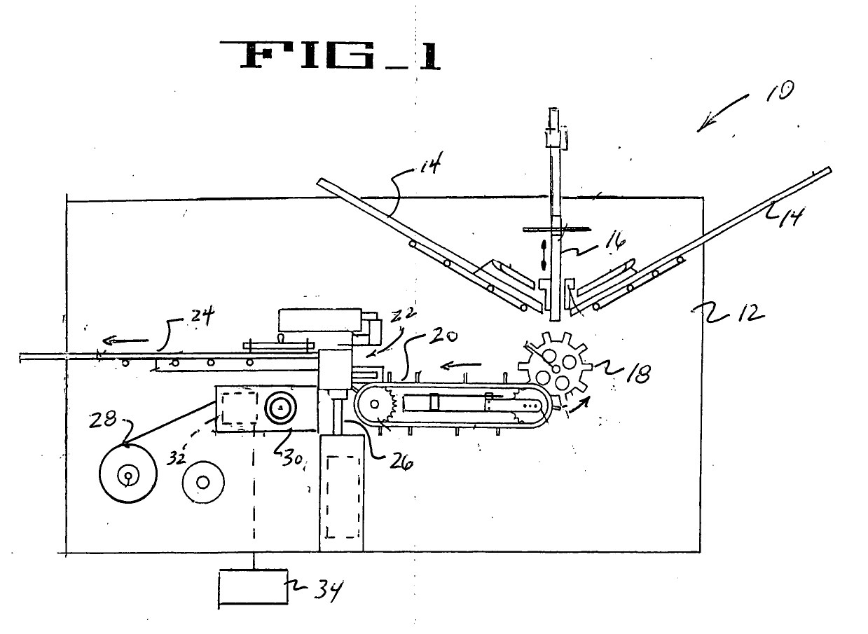

With reference to FIG. 1, therein is illustrated an apparatus 10 for making and wrapping ice cream novelties, in particular, ice cream sandwiches, embodying the principals of the present invention. Apparatus 10 includes a frame 12 upon which various components of the apparatus are mounted for operation in unison, whereby ice cream sandwiches are sequentially formed and wrapped, and directed down a discharge conveyor to an associated cartoning apparatus. Features of the present ice cream sandwich making machine 10 will be familiar to those skilled in the art. In particular, the apparatus includes a pair of wafer magazines or trays 14 arranged in generally downwardly converging relationship, on respective opposite sides of an ice cream dispensing nozzle 16, positioned generally intermediate the wafer magazines. Nozzle 16 is reciprocably movable so that attendant to reciprocation, ice cream from the nozzle is dispensed between a respective pair of wafers from the magazines 14, thus sequentially forming a plurality of sandwiches each comprising a pair of the wafers with ice cream therebetween.

A transfer rotor 18 is positioned beneath the wafer magazines, with openings spaced about the periphery of the transfer rotor configured to each receive one of the sandwiches being formed. Transfer rotor 18, in turn, moves each sandwich through an arc of approximately 90 degrees (counterclockwise in the illustration of FIG. 1), with the sandwiches thereafter sequentially received on a sandwich conveyor 20 of the apparatus.

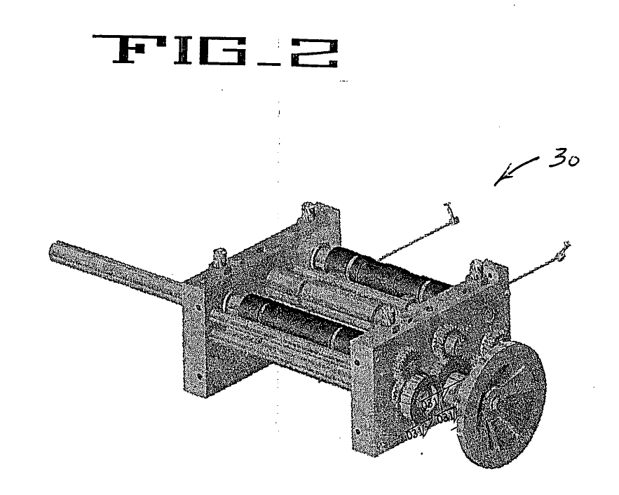

From sandwich conveyor 20, each of the sandwiches is directed through a sandwich wrapper, indicated generally at 22, where each sandwich is individually wrapped, and thereafter moved out of the apparatus along discharge 24. Wrapping of each sandwich is effected by vertical movement of each sandwich by a sandwich elevator 26, which moves each sandwich upwardly through a wrapping chute of sandwich wrapper 22, whereby each sandwich is individually wrapped with wrapping material from an associated feed roll 28. The wrapper 22 includes a cutting mechanism 30, which is shown in FIG. 2, includes an arrangement of cooperating knife and anvil rolls whereby individual segments of the wrapping material are cut for wrapping about each of the sandwiches being wrapped.

As noted above, apparatus 10 typically includes a single, electric drive which drives the various components of the apparatus in unison with each other. Changes in the drive relationship are typically effected by changing associated gearing, belts, cams, etc. Heretofore, a change in the size of sandwiches being made typically require changing the gearing in the wrapper mechanism 22 to appropriately change the amount of wrapping material delivered and cut for individually wrapping each of the sandwiches.

In accordance with the present invention, the wrapper mechanism 22 includes a servo-driven wrapper feed mechanism 32, operated by suitable controls 34, whereby the wrapper feed mechanism is operable independently of the drive of the cutting mechanism 30. By this arrangement, versatile operation of the apparatus 10 is greatly facilitated, since operation of the wrapper feed mechanism 32 can be readily and easily altered, via controls 34, to feed a desired amount of material for wrapping sandwiches of differing sizes. The servo-driven wrapper feed mechanism further facilitates conversion of the apparatus to registered print wrapping material without mechanical changeover.

Notably, during development of the present invention, it was found that properly matching wrapper feed, with starting and stopping of the apparatus 10, could be difficult and problematic. Significantly, the present invention permits operation of the wrapper feed mechanism to reset the position of the wrapping material attendant to stopping of the apparatus 10. In particular, the wrapper feed mechanism can be operated to retract a leading edge of the wrapping material, thus desirably avoiding excessive feeding of the wrapping material, which can otherwise cause jamming through the wrapping and elevator mechanisms of the apparatus.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

What is claimed is:

1. An apparatus for making wrapped ice cream sandwiches, comprising:
a pair of wafer magazines for respectively retaining a plurality of wafers;
a dispensing nozzle positioned generally intermediate of said wafer magazines for dispensing ice cream between respective pairs of said wafers to sequentially form a plurality of said sandwiches each comprising a pair of said wafers with ice cream therebetween;
a transfer rotor positioned beneath said wafer magazines for receiving each of said sandwiches;
a sandwich conveyor for sequentially receiving said sandwiches from said transfer rotor for advancement therefrom;
a sandwich wrapper positioned downstream of said sandwich conveyor for sequentially receiving said sandwiches from said conveyor for individually wrapping each sandwich;
said wrapper including a wrapper feed mechanism for advancing wrapping material from a roll thereof, and a cutting mechanism for cutting individual wrappers form said wrapping material,
said wrapper feed mechanism including a servo-drive operable independently of a drive for said cutting mechanism, to thereby facilitate wrapping of ice cream sandwiches of varying sizes.

2. A method making wrapped ice cream sandwiches, comprising the steps of:
providing an apparatus, including providing a pair of wafer magazines for respectively retaining a plurality of wafers;
providing a dispensing nozzle positioned generally intermediate of said wafer magazines, and dispensing ice cream between respective pairs of said wafers to sequentially form a plurality of said sandwiches each comprising a pair of said wafers with ice cream therebetween;
providing a transfer rotor positioned beneath said wafer magazines, and receiving each of said sandwiches in said transfer rotor;
providing a sandwich conveyor for sequentially receiving said sandwiches, and transferring the sandwiches from said transfer rotor for advancement along said conveyor;
providing a sandwich wrapper positioned downstream of said sandwich conveyor, and sequentially receiving said sandwiches from said conveyor, and individually wrapping each sandwich;
said wrapper including a wrapper feed mechanism for advancing wrapping material from a roll thereof, and a cutting mechanism for cutting individual wrappers form said wrapping material, and
operating said wrapper feed mechanism independently of the speed of said cutting mechanism, to thereby facilitate wrapping of ice cream sandwiches of varying sizes.

3. A method of making wrapped ice cream sandwiches in accordance with claim 2, including:
operating said wrapper feed mechanism to reset the position of the wrapping material attendant to stopping of said apparatus.

4. A method of making wrapped ice cream sandwiches in accordance with claim 3, wherein:
said step of operating to reset includes retracting a leading edge of said wrapping material.
